(19) United States
(12) Patent Application Publication
(10) Pub. No.: US 2015/0341185 A1
(43) Pub. Date: Nov. 26, 2015

(54) CONTROL MODULE AND CABLES FOR NETWORKING ELECTRICAL DEVICES

(71) Applicant: Walter KELLER, Medford, OR (US)

(72) Inventor: Walter Keller, Medford, OR (US)

(21) Appl. No.: 14/759,181

(22) PCT Filed: Jan. 7, 2014
(86) PCT No.: PCT/US14/10534

§ 371 Date: Jul. 2, 2015

Related U.S. Application Data
(60) Provisional application No. 61/749,818, filed on Jan. 7, 2013.
(60) Provisional application No. 61/749,809, filed on Jan. 7, 2013.

(51) Int. Cl. H04L 12/28; H04W 4/00; G05B 19/042

(52) U.S. Cl. CPC H04L 12/282; G05B 19/042; H04W 4/005; H04L 2012/2841; H04L 2012/285

(57) ABSTRACT

Systems are described for controlling electrical (typically unautomated electrical) devices with a programmed control module including electronic memory and a computer processor together with a selection of purpose-specific cables selected from any of infrared IR (send and/or receive), serial cables, power cables, sensor cables or others. One such additional example is a relay/contact-closure cable includes circuitry for modifying its communication parameters and/or providing a power boost for expanded power-intensive uses. A serial cable includes circuitry for modifying its gender and/or other communication parameters. A system or kit includes the cable and a conversion connector to physically alter cable connection gender. Such a system or kit may also include the control module.

### RELATED APPLICATIONS

This filing claims the benefit of and priority to US. Provisional Patent Application Nos. 61/749,809 and 61/749,818, each filed Jan. 7, 2013 and each incorporated by reference herein in its entirety for any purpose.

### FIELD

The subject filing relates to systems for home and/or commercial networking of electrical devices and more particularly to machine-to-machine (M2M) communication and control interfaces.

### BACKGROUND

The assignee hereof, Global Cache, is recognized for providing state-of-the-art products that network-enable (often) unautomated devices in control and automation systems. The company's award-winning iTACH family of products and GC-100 network adapters enable connecting a wide array of electrical devices to any network for control and/or automation.

Further, as announced on Nov. 12, 2012 an invention embodiment hereof (described as the iTACH FLEX) was named a CES Innovations 2013 Design and Engineering Award Honoree in the Home Networking category based on a confidential evaluation of its features by a preeminent panel of independent industrial designers, engineers and members of the media. The prestigious Innovations Design and Engineering Awards are sponsored by the Consumer Electronics Association (CEA), the producer of the International Consumer Electronics Show (CES), the world's largest consumer technology tradeshow, and have been recognizing achievements in product design and engineering since 1976. Such innovations entries are judged based on the following criteria:
engineering qualities, based on technical specs and materials used;
aesthetic and design qualities, using photos provided;
the product's intended use/function and user value;
unique features that consumers would find attractive; and
how the design and innovation of the product compares to other products in the marketplace.

Thus, the subject embodiment and those related thereto as described be believed to represent a significant advance in the relevant art.

### SUMMARY

Embodiments hereof may be regarded as providing a smart end-point that TCP/IP enable other electrical/electronic devices over WiFi and Wired networks, wherein such (other) devices are typically, though not necessarily, previously unautomated or at least not well-integrated with other control options. Such lack of automation may be by reason of given proprietary protocols, limited development, etc.

A control module and/or automation module (hereinafter referred to as a “control module” without any intent to suggest a limitation of its function) in the subject system is configured to (in a sense) add intelligence to the previously unautomated device, enabling or allowing events and tasks to be triggered with simple macro commands or otherwise. In addition, the control module optionally supports HTTP for web browser control from anywhere in the world (generally a “remote location”) and optionally includes a real-time clock to support timed events for true automation.

More particularly, systems are provided comprising a control module independent (i.e., originally separate) from an electrical/electronic device wherein the control module includes electronic memory (typically though not necessarily RAM) and a processor to execute instructions and a first connector through which signals are passed. The subject systems further comprise a communication cable, the communication cable includes a second connector at one end and an active interface at another.

The processor is configured through software programming to receive electronic commands from a (typically remote) user interface device, execute instructions based on the commands and information stored in the memory, and provide for electronic communication through/with any of an infrared (IR) cable, a relay or contact-closure cable and a serial cable or other functional cables. Importantly, the multiple cables for such use include the same controller-side connector despite their different type of active end/interface. The common connector feature enables form factor and ease of use considerations —alike—important to the invention embodiments as discussed further below.

The subject control module with selectable cables provides inexpensive and simple connectivity to common household devices so that they can optionally be controlled/automated using an application (an “App”) on a smart phone, tablet, or any other user interface device. The control module may, for example, connect to both an RJ45 (Ethernet) network cable and power supply via mini USB or otherwise. If the control module is Power over Ethernet (PoE) enabled, connecting a separate power supply is not necessary. Still further, the controller/control module may be battery-powered.

The small footprint of the control module (e.g., measuring 6.5 cm×3.9 cm×1 cm for a WiFi version, and 6.5 cm×3.9 cm×2.1 cm for a wired version, with each weighing less than 1 oz.) is suitable for transparent coupling and seamless integration to any device in homes or businesses. The device advantageously has a volume of about 50 cm³, and more preferably about 30 cm³ or less. In some examples, each unit may be interfit with a stamped metal cradle with screw holes that can be attached to walls or other surfaces. Due to its small size and weight, the product can be attached to many devices being WiFi or networked enabled through its use.

The hardware form, with a WiFi or network connection to a 3.5 mm jack (or other controller-side connector) and control module adaptation supporting a variety of protocol translation cables, offers the ability to bridge products and systems. The control module connects an electrical device to a WiFi or wired Ethernet network to access, monitor, automate, and/or control standalone equipment. In addition, the consistent/uniform controller-side connection supports sensor input, connecting off-the-shelf sensors to the network, the internet, and the cloud.

This means that almost state changes, including temperature, power, security alarms, and much more can be sent over the internet to inform the user in any of a variety of ways. An example of such communication would be a text message sent inform users that they have left the garage door open, or that there is a serious water leak in the home.

Entertainment systems may be the most common household devices to be controlled, and most of those devices respond to IR codes from infrared commands sent by a typical remote control. As such, an advantageous option includes programming for coordinated code and driver retrieval. In the former case, a cloud-based service may provide the required IR codes for the equipment being controlled. The ease-of-use and versatility of the cloud-based exemplary systems ensures compatibility and expandability of many systems. The control module optionally also offers built-in IR learning with an integrated IR sensor.

In any case, by employing multiple control modules (with each one near or at the location of a selected stand-alone device to be controlled), a scalable and simple to use system is provided. As such, the subject control module provides for distributed automation and control, with smart end-points that enhance and connect standalone devices that are accessible and controllable by remote user interface devices.

Such a system offers control solutions to new and old devices alike. No custom hardware or integrated socket or socket retrofit altering the hardware is required. Rather, existing hardware is leveraged and seamlessly integrated into and creating a new network of control possibilities. The subject hardware (in terms of a control module and an appropriate cable) is selected and the control module and/or or any “smart” cable connected thereto is electronically configured.

Notably, the subject “cable” may vary in length. Further, it is contemplated that it has no length or substantially no length bridging between its connector and active interface ends. And while the cable may have a linear (or coiled configuration for storage/management) it may be otherwise laid-out as in an compact “L” format, etc.

Regarding these “smart” cables, one example described in detail below is for RS232 communications and designed to avoid the problems commonly encountered when establishing serial communications between electronic devices. Features of this so-called “genderless” serial port cable for a networking control allow a user not familiar with serial port cable devices to successfully interconnect them for proper communications.

Areas optionally addressed with this serial cable include matters in which: a) physical connection is accomplished by providing both a female and male gender connector, b) correct driver pin-outs are determined and configured electronically in connection with a control module interface, and/or c) communication speed and data structure are resolved by a trial-and-error sequence at communications initiation. Any or all of the auto-setup can be overridden or re-started with a new device connection. The device the subject cable is connected to is typically (though not necessarily) a control module as described herein.

In one example of operation, a software driver is employed to determine data speed and structure. The driver is specific to the device which is connected to the cable. For example, when connecting a serial cable to a Sony DVD player, the Sony DVD software driver is selected by the user. The driver transmits commands to the device at well-known serial data rates, measuring the received data returned by the device. Communication is established by this trial-and-error method, a) where the smallest data bit period is measured to determine transmit speeds, b) data bit locations are determined by recording their respective time slot within the overall serial stream, c) and the parity setting is calculated for ODD, EVEN, or NONE. This process continues to narrow down possible solutions until only one remains. After a unique communication solution is found, the software driver resets the device to a known state for proper operation.

Another example of a “smart cable” applicable to the subject system and/or or otherwise employed embodies a relay or contact-closure interface. As with the other cables, such a device optionally includes a standard first end (i.e., standardized to interchangeably operate with the subject control module in lieu of or together with other cables (e.g., if a “splitter” is employed).

As to individual (i.e., cable-specific) features, the hardware is optionally configured to include inputs for voltage or contact closure sensing and outputs for on/off or relay actuation (any of such functions offering examples of “electronic communication” in the sense intended herein). At least the cable will include such outputs and output functionality. In connection with the outputs, the circuitry may include circuitry (generally a capacitor, a bank of capacitors and/or battery such as a rechargeable coin cell) to store energy from a low power input and release a larger/higher-power burst in order to actuate larger relay mechanisms than would otherwise not be possible given power limitations. As such, the cable, in one example, may also provide a power management system. Such function and options associated therewith are described in further detail below.

In sum, the inventive variations hereof include systems comprising any combination of the features described herein.

### BRIEF DESCRIPTION OF THE DRAWINGS

The figures diagrammatically illustrate aspects of various embodiments of different inventive variations. Of these, the figures variously show:

FIG. 1 is a block diagram of the cloud-based hardware and software architecture optionally employed in the subject system;

FIG. 2 is a block diagram of the subject system.

FIGS. 3A and 3B picture open and closed-shell views of a first control module embodiment:

FIGS. 4A and 4B are open and closed-shell views of a second control module embodiment (rotated 180 degrees relative to the FIG. 3A/3B embodiment);

FIG. 5A pictures a control module system with IR send and receive cables; FIG. 5B is a view of the reverse side of a control module with its mounting system;

FIG. 6 pictures a multi-end IR cable control system;

FIGS. 7-10 picture an array of other cables suitable for use with the control modules (including video sensor cable—FIG. 7, voltage or contact closure sensor cable

FIG. 8, male and female serial cables

FIGS. 9A and 9B and a genderless serial cable system

FIG. 10 including a cable and a physical connector/converter);

FIG. 11 pictures a system comprising a cable as in FIG. 10, together with a control module;

FIG. 12 pictures a system comprising a control module and relay cable;

FIG. 13 is an open-shell view of the cable shown in FIG. 12;

FIG. 14 is a block diagram illustrating various features and operation possibilities of the system in FIG. 12;

FIGS. 15A-15C are flowcharts illustrating optional control device, server and client/browser s software algorithms for the system in FIG. 1; and

FIG. 16 is a flowchart illustrating optional operation of the genderless serial cable system in FIGS. 10 and 11.

Variations of the embodiments shown in the figures are contemplated and shall be considered within the scope of the claimed invention(s) explicitly or under the Doctrine of Equivalents.

### DETAILED DESCRIPTION

The subject matter of embodiments of the present invention is described here with specificity to meet statutory requirements, but this description is not necessarily intended to limit the scope of the claims.

Optional features of the subject hardware and software systems are presented in the table below as possible specifications; these are representative and may vary:

| Power Input | 5 V DC@250 mA (90 to 230 V wall power adapter included) |
|---|---|
| | International plugs available |
| | USB micro adapter cable draws power from USB port (included) |
| Setup & | Integrated web server for easy configuration |
| Configuration | Wireless: |
| | Adhoc network for peer-to-peer setup |
| | WPS (WiFi Protected Setup) |
| | Pushbutton connection to the network takes only moments |
| iHelp Setup Utility | Downloadable iHelp software simplifies network discovery and setup |
| IR Learning Utility | Downloadable iLearn software allows for the capture and playback |
| | of IR commands for control uses |
| Network | DDHCP and static IP |
| Connection | Wired TCP/IP |
| | RJ45 standard Ethernet connector |
| | 100/10 Mbits Ethernet protocol |
| | Wireless/WiFi |
| | Infrastructure and adhoc network types |
| | WiFi 802.11g with on-board antenna |
| | WPA/WPA2 (TKIP, AES & Mixed) |
| | WEP 64 bit |
| | WEP 128 bit |
| | WPS |
| LED Indicators | Power and connectors to indicate activity and status |
| Global Port | 4 Conductor connection (TRRS: tip, ring, ring, sleeve) |
| | Allows for versatility through the use of our Flex Link cables |
| Serial/RS232 | Male DB9 with automatic configuration sensing |
| | 600 baud to 115.2 Kbaud data rates supported |
| | Odd, Even, and None parity settings |
| | Bi-directional with hardware RTS/CTS flow control |
| Flex Link Cables | Supports IR Out, IR Blaster, IR Tri-Port and Serial |
| IR Output | 3.5 mm connector |
| | Supports |
| | IR Emitter |
| | IR Blaster |
| | IR Tri-Port (emitter-emitter-emitter or emitter-emitter-blaster) |
| | GC-CGX - For Xantech compatibility |
| Control APIs | TCP |
| | ASCII textural commands compatible with iTech and GC-100 protocol |
| | Comma delimited, carriage return terminated |
| | HTTP |
| | New web-based control using HTTP commands with JSON payload data |
| File Storage | Store web pages and files in a standard FAT file system |
| | Accessible via URL from any location on or outside the network |
| | Allows for web page control of your devices |
| Mounting Dock | Allows for simple installation in any location |
| | Screw down the mounting dock and Flex units can be clicked in |
| | and out as needed |
| Dimensions | L × W × H Wired |
| | 2.58″ × 1.22″ × 0.82″ |
| | L × W × H WiFi |
| | 2.55″ × 1.22″ × 0.48″ |

### Hardware Overview

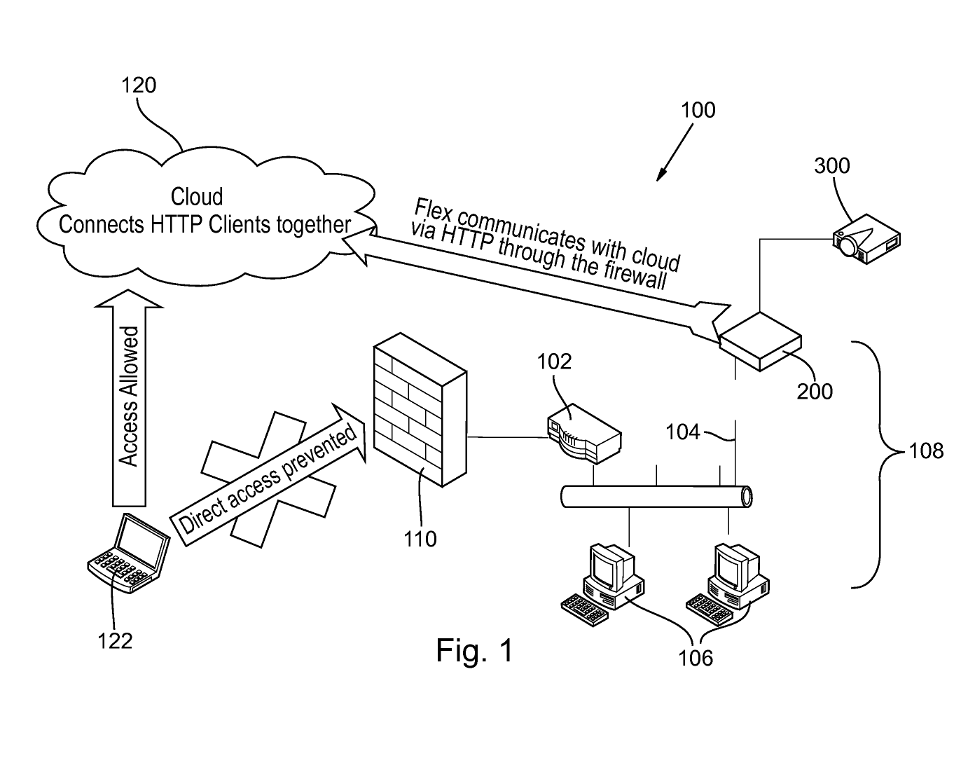

In connection with the figures below, systems are shown and further described suitable to meet such specifications. Specifically, FIG. 1 shows an example of a system 100, in accordance with one aspect of the present invention, that includes a control module 200, connected (via a cable interface as further described) to an standard electronic device 300 (a projector in this case) to be controlled by the subject control system.

Controller module 200, in this example, is connected to an Ethernet hub 102 (by wired connection 104 in this case, but it may be connected wirelessly). Additional computers 106 may be similarly connected in a local network 108. The network is protected by a so-called firewall 110.

The control module is able to communicate (through the firewall via HTTP) to the computing Cloud 120, an architecture where one or more of a system's services, functionality or data are physically hosted in one or more remote data or resource centers. Similarly, whereas the firewall prevents a non-networked computer 122 from interfacing directly with the network (unless or until authorized via a correct pass code or otherwise added to the network), this computer can connect to the Cloud and direct control module 200 activity through a pair of HTTP clients.

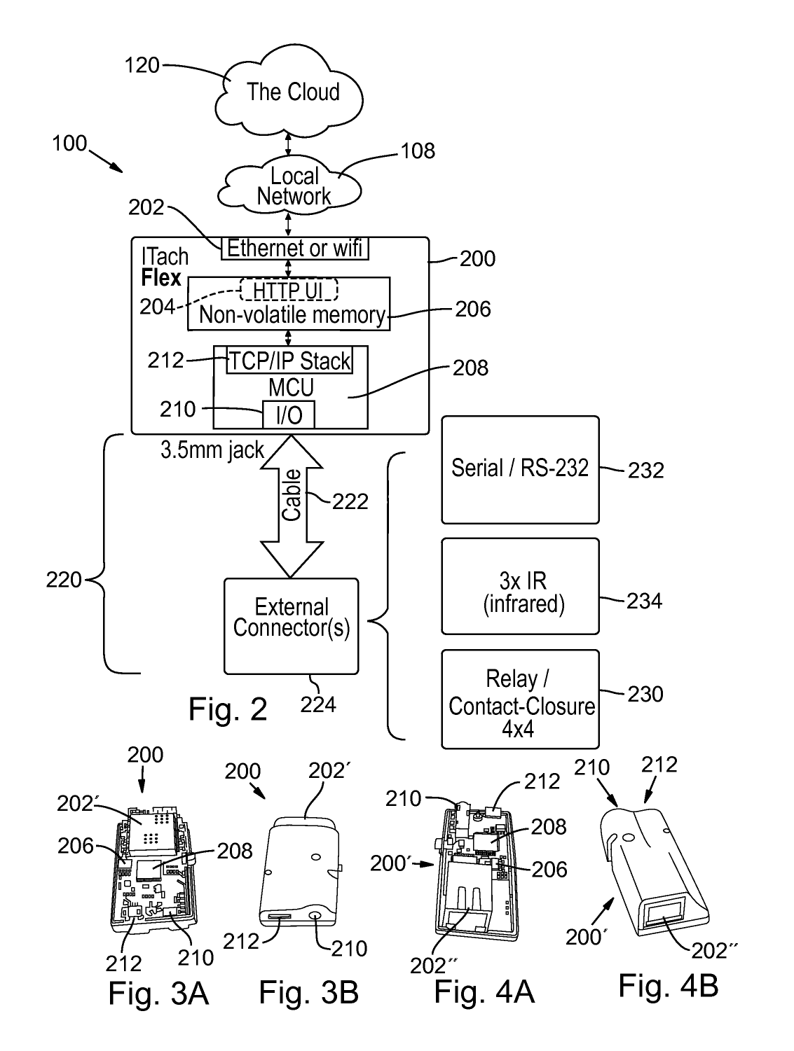

FIG. 2 details one example for control module 200 and its interface features. Connections between the Cloud 120, an optional intermediate local network 108 and a control module 200 are illustrated in the example shown. Features of this control module include an Ethernet or WiFi 202 module for such connection.

As referenced above, a HTTP User Interface (UI) 204 is optionally programmed and stored in memory 206 (preferably non-volatile memory). The UI enables web-based user communication and control of module 200 via a remote or networked computer (as in computers 106 and/or 122 in FIG. 1) together with its associated connections. In the control module, a microcontroller (MCU) 208 is connected to the memory as well as Input/Output (I/O) 210 elements of the electronic hardware. A Transmission Control Protocol (TCP) and the Internet Protocol (IP) stack 212 also stored memory is run on the MCU in this example.

Preferably, the I/O's are managed over a single 3.5 mm socket and jack interface in this example. However, other physical connector or connection options for a selection of cables are possible as well.

The cable(s) 220 to be used include a body 222 (generally, though not necessarily an elongate wire extension) and one or more external connectors 224. These “connectors” may connect physically (e.g., as by wiring in a relay/contact-closure example 230 serial/RS-232 example 232) or connect remotely (e.g., as by infrared radiation (IR) transceivers). Generally, the connector(s) 224 provide an active interface for or to the device to be controlled and are at the end of the cable as further discussed below, though other options are possible as well.

As for more detail regarding examples of the control module hardware, FIGS. 3A and 3B picture open and closed-shell views of a first control module embodiment 200 and FIGS. 4A and 4B show open and closed-shell views of a second control module embodiment 200′. Embodiment 200 includes a WiFi module section 202′. Embodiment 200′ substitutes an Ethernet module 202″. Power may be provided over the latter (as in PoE). Alternatively, power may be provided to the units via micro USB port 212 as variously shown. A 3.5 mm I/O socket 210 is also shown as are memory 206 and MCU 208 components.

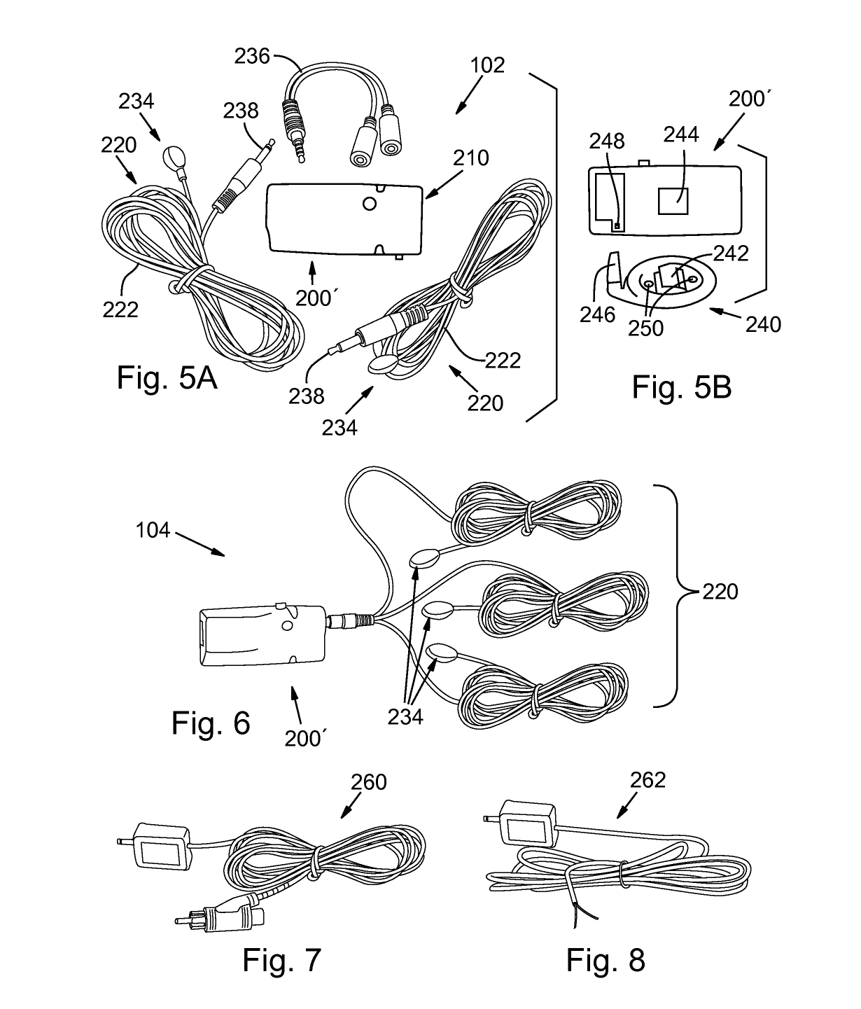

FIG. 5A pictures an example of a control module system 102 with IR emitter (send or output) cables. Each such cable 220 includes a body 222 and external IR interface element 234 on one end and a 3.5 mm jack 238 at the other end. By virtue of the interface element, the cable may be a dedicated send cable as shown (with an emitter—optionally a IR “blaster” to send signals across a room or space), dedicated receive cable (with a sensor to capture and digitize IR signals) or one capable of send and receive (as in “transceiver” type interface). This example of a cable may be plugged-in to I/O port or jack 210 or multiple ones may be connected using a Y-type two (or more) way splitter 236.

As for other hardware options, FIG. 5B pictures the reverse side of a control module 200′ with an example of an optional mounting attachment 240. This attachment includes a tang or tab 242 suitable to interfit with a socket 244 in the controller body shell. A latching arm 246 optionally provides for a secure, but releasable capture of the control module to attachment 240 via a detent feature 248 once the mounting attachment is affixed (e.g., via screws past through holes 250, an adhesive backing or another approach—none shown) to a surface.

Naturally, the mounting surface may be that of the electronic device 300 to be controlled by the subject system. Alternatively, the control module 200 may be secured to a nearby structure such as a wall or A/V cabinet furniture, etc. In any case, the control module may be located wherever is convenient. It may be hidden from sight with only cables 220 having their ends 224 set adjacent or nearby the electrical device(s) be controlled. As such, the subject system allows for remote and/or unobtrusive placement of elements. As referenced above, the control module and its system components provides for a smart end-point easily and effectively integrated within an overall (A/V or other) system that exists or is to be built-up from scratch.

In any case, FIG. 6 pictures an example of a multi-channel IR control system 104 in accordance with another aspect of the present invention. Here, cable 220 includes a multi-emitter array of active IR elements 234. In such an approach, no splitter (like 236 in FIG. 5A) is required to achieve multiple cable inputs and/or outputs to control multiple devices (e.g., as in a projector device 300 together with an A/V stack that might include a receiver and Blu-ray player—the latter devices not shown).

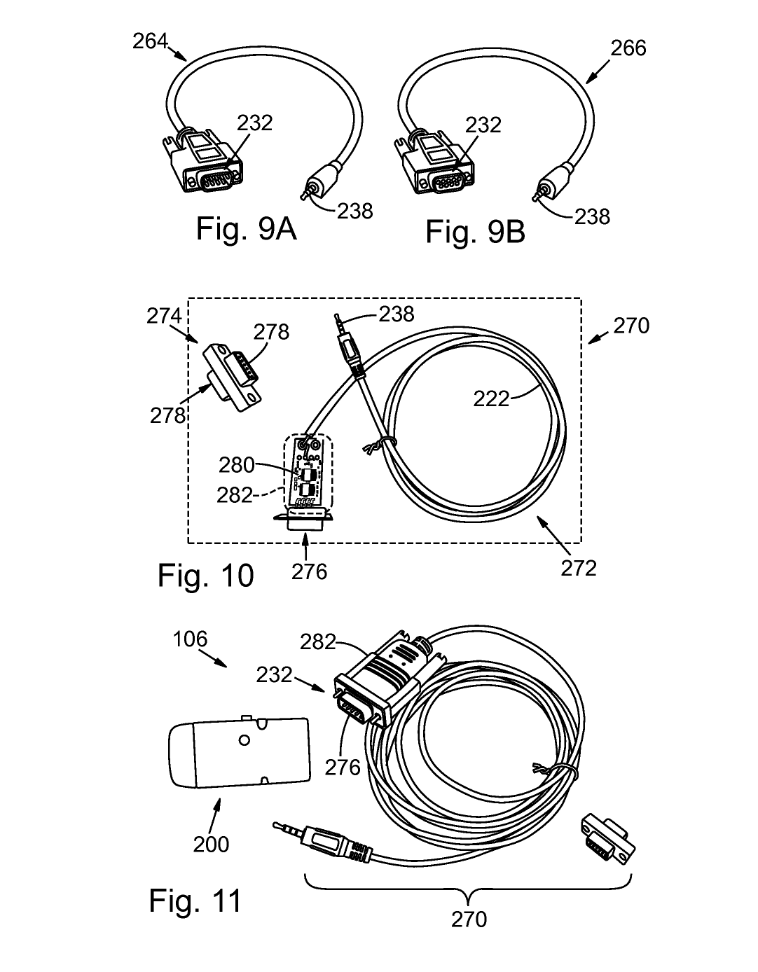

As referenced above, other types of cables may be employed in a control system in accordance with certain aspects of the present invention as well (i.e., alternatively or additionally). Examples of such are provided in FIGS. 7-10. FIG. 7 pictures a video sensor cable 260 and FIG. 8 pictures a voltage or contact closure sensor cable 262. Male and female serial/RS232 cables 264, 266 are shown in FIGS. 9A and 9B, respectively. As with the other cables (i.e., those shown and described above and below) these include an external connector end (i.e., a serial pin or socket interface 232 for cables 264, 266) and a suitable (universal, at least across the various cable types) connector 238 for the control module 200, 200′.

### Genderless Serial Cable

FIG. 10 pictures an example of another type of control module cable in accordance with aspects of the present invention. This one may be regarded as a “smart” cable as with any of the above in that it can be used in coordination with the control module without requirement of user-specific configuration. However, this cable embodiment may be regarded as possessing additional so-called intelligence in defining a “genderless” serial cable.

In this example, cable system 270 includes a cable 272 and a physical connector/converter 274 optionally used with a male pin socket interface 276 to change its physical gender at the active interface end of the cable body 222 from a male pin to a female socket interface 278.

However, such a gender change using a female-to-female converter—alone—would not produce a functioning cable. The pins (or, holes, with converter 274 connected inline with the serial-port enabled electronic device to be controlled and/or monitored) must be reconfigured. Integrated Circuit (IC) board 280 serves this purpose as further described below in connection with software options hereof. The board may be contained/molded within a cover, shroud or molding 282—such as in consumer or market-ready version like that shown in FIG. 11.

Notably, the cable 272 and converter/connector 274 may be provided as a system (or sub-system) in packaged combination as indicated by dashed line in FIG. 10. Otherwise, the components may be so-provided in a system 106 as shown in FIG. 11.

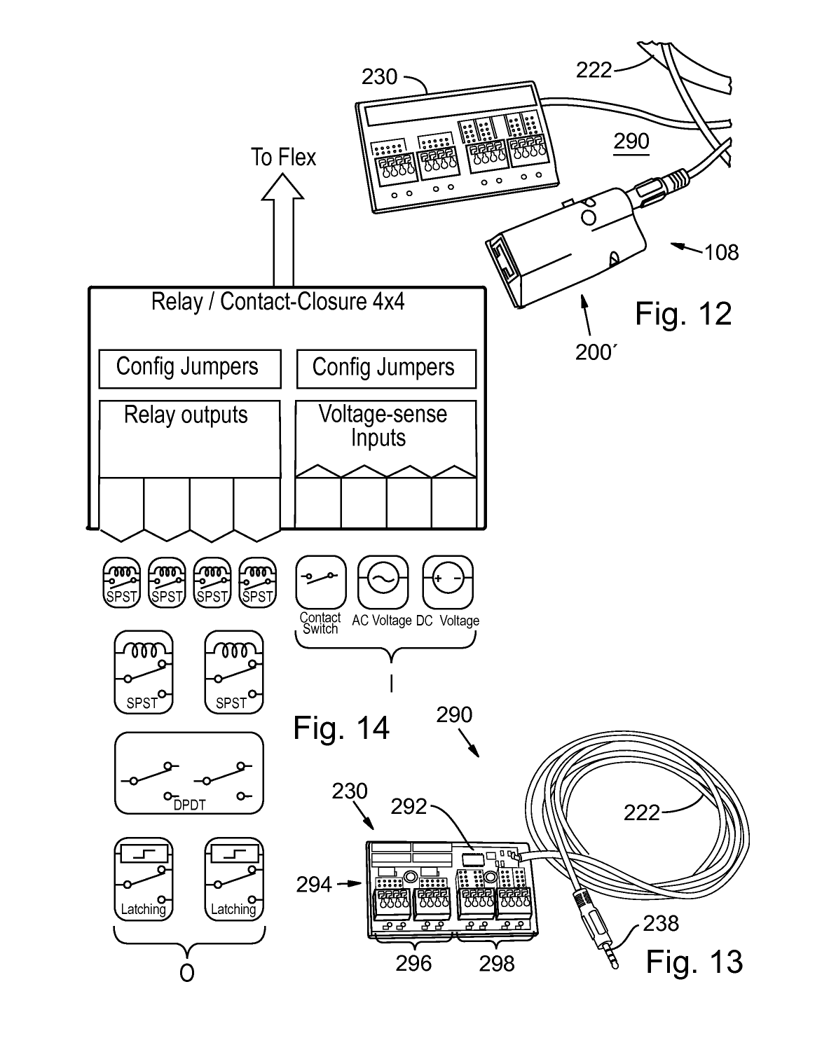

### Relay/Contact-Closure Cable

Whereas cable 262 in FIG. 8 is adapted to sense contact closure, a more complete suite of control cable functionality is possible with the system and cable variously pictured in FIGS. 12 and 13. FIG. 12 pictures an example of a system 108, in accordance with some of the aspects of the present invention comprising a control module 200′ and relay cable 290. FIG. 13 shows an open-shell view of the cable 290 shown in FIG. 12. Here, IC board 292 and an array of configuration jumpers 294 are exposed to view. A plurality of relay outputs 296 and voltage-sense inputs 298 can also be seen.

FIG. 14 is a block diagram illustrating various features and operation possibilities of cable 290 as used in a system 106. By virtue of the on-board control offered by IC board 292 various relay output states “O” may be achieved. Likewise, a variety of voltage-sensing inputs “I” can be monitored. In one example, the relay circuitry may include energy storage means “E” (e.g., one or more capacitors, super-capacitor(s), rechargeable cell(s) or another element) for storing low-power input received via connector 238 that may be stored and sent to a relay device having a higher power requirement (such as a large solenoid) for actuation.

The functionality illustrated in FIG. 14 may be accomplished with a cable remotely controlled by an end-point control module 200, which may provide enhanced functionality and a reduced form factor. In accordance with certain aspects of the present invention, the system described may provide flexibility with respect to the use and placement as well as ultimate functionality. A myriad of functions may be implemented utilizing various embodiments of the present invention, including setting and monitoring, contact closure on drapery controllers, thermostats, security contacts, and door strikes. Moreover, these tasks may be accomplished with a control module that is no different than that used in any of the applications above given the subject system architecture.

### Software

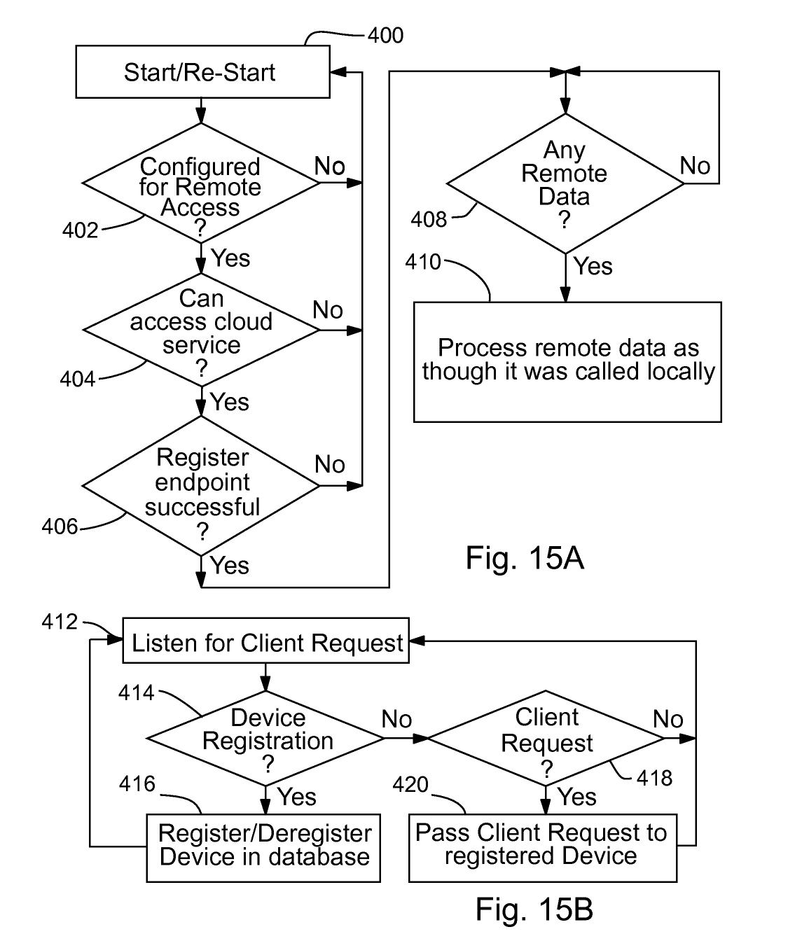

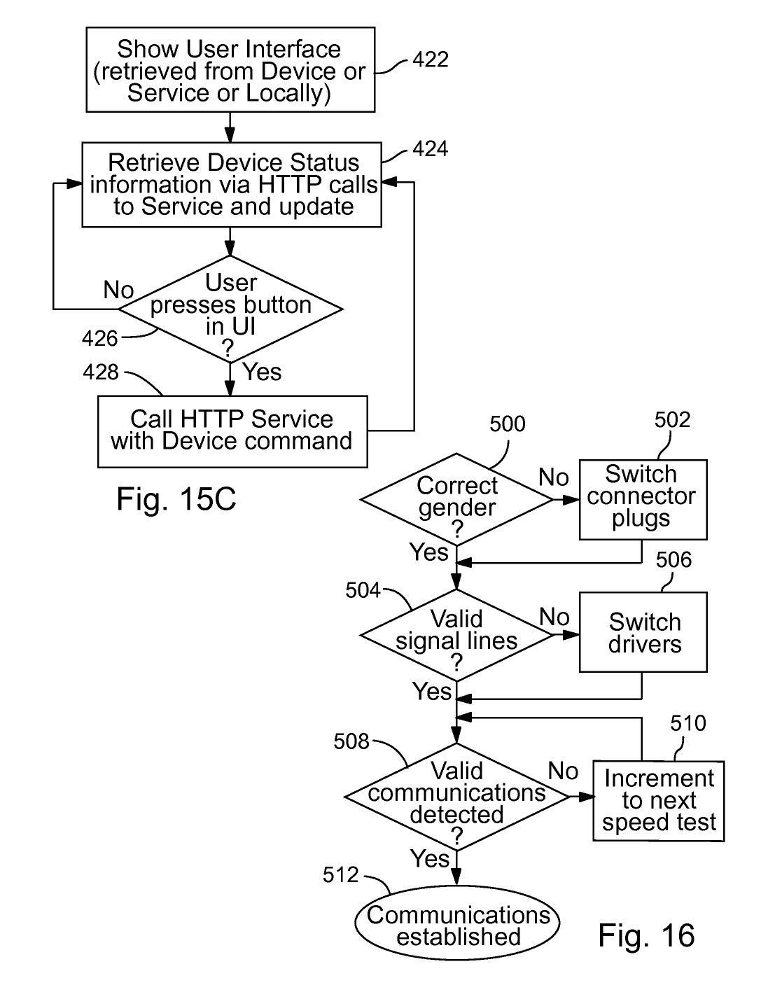

FIGS. 15A-150 are flowcharts illustrating examples of optional control module device, server and client/browser software operation for the systems variously described and detailed in FIG. 1. FIG. 16 is a flowchart illustrating one example of optional operation of the genderless serial cable system in FIGS. 10 and 11.

In reference to the system described in FIG. 1, by default, the control module may use DHCP to automatically obtain an IP address from a router when connected to the Internet or other computer communications network. To confirm connectivity to the network, a power LED of the control module may blink at a given rate. To determine the unit's IP address, in one example, one can download a program from the Internet and run it on a Windows PC or MAC that is connected to the network. Such an application may listen for multicast beacons and display IP address and other details within a short time. In the event there is no DHCP server present, control module units in default conditions may reside at a default address. The control module is easily programmed employing a configuration program that can be brought up by entering the unit's IP address in a web browser. To use an optional USB configuration functionality, in another example, one may connect the control module to a computer using a USB micro cable. Once connected, a configuration utility may be used to apply network and connector related settings. Once applied, in this example, settings will remain active in the unit until reconfigured and the cable can be removed from the computer.

As referenced, embodiments of a control module in accordance with certain aspects of the present invention are able to work with at least IR cable and serial cable interfaces with a common control-module side connector (be it a female jack, male plug, a USB interface or other option). Alternatively, other combinations of cables including relay cables (selected from the above or otherwise) may define a minimum set for compatibility within the scope of certain embodiments of the invention. In these examples, the control module (by virtue of its electronic architecture and programming) is adapted (by a combination of hardware and programming) for use with at least two classes of cables. More preferably, it may be used with three or more classes. Through various connection possibilities, the subject control modules and associated software can control, for example, Blu-ray/DVD players, flat panel TVs, remote controls, stereo components, cable boxes, speakers, TVs, computers, electric motors, motorized window shades, pool and spa equipment, lighting, garage doors, complex conference/AV room setups, etc.

Solutions so-provided optionally involve the control module calling out, via HTTP, to an endpoint in the Cloud as illustrated in the example of FIG. 15A. This action may be to a service that the assignee hereof hosts and is accessible via the internet or another wide area communications network. Such action may begin at 400, after which a determination is made if the control module is configured for remote access at 402. If so, a determination is made if the control module can access available Cloud computing service(s) at 404. If so, a check can be made as to whether the control module is successfully registered at 406. If this check is successful, an inquiry can be made as to whether any remote data (such as commands, instructions, etc) is available at 408. If so, such data can be processed just as if it were provided locally to the control module at 410. Failure of any given inline check may cause the system to re-check or re-start recursively. Other examples of remote device configuration and registration processes may be implemented in various embodiments without departing from the scope of the present invention.

However managed, at the server side, related activity may be accomplished as shown in the example of FIG. 15B. Specifically, at 412 a computer system is open or available to receive or “listens” for a client request. Upon receipt control module device registration is checked at 414. If the Client request is for control module device registration or de-registration, this is accomplished at 416. If a Client request is checked as being such at 418 and being made to direct the control module, this is passed to the registered device at 420 for action. In any case, since outbound HTTP traffic is generally allowed through a firewall, no problem should arise from this activity. Certainly, in instances in which a user can surf the Internet from within the network, then the control module can register with the service. Other examples of registration and request processing services may be implemented in various embodiments without departing from the scope of the present invention.

Additionally, from a browser outside of the network, one will be able to make an HTTP request to the service and discover and connect to the endpoint that the control module had previously registered as illustrated in the example of FIG. 15C. Such activity may begin at 422 by showing a User Interface (US) retrieved from the Control Module, Cloud-Based service or Locally on a network. At 424, Control Module status may then be retrieved via HTTP calls. Then if a user selects a feature in the UI (e.g., by pressing a “button”) at 426 a device command is issued by HTTP service at 428. Whether or not such activity occurs, however, the system may recursively update Control Module status as indicated. Other examples of user interface and device control processes may be implemented in various embodiments without departing from the scope of the present invention.

Notably, control activity may be accomplished through a variety of communications infrastructure, such as a cell phone network, WiFi network, etc. In one example, when the browser issues a command up to the cloud, the service returns the HTTP request back to the control module and from its perspective, it would have simply returned from a lengthy HTTP GET request. The HTTP response will contain the necessary information for the control module to process the command and send any response back up to the cloud via a subsequent HTTP request which will then get returned back to the browser. All this is done seamlessly and most importantly, in a scalable manner. Also, authentication may be optionally done in the cloud. As such, remote users can be turned on and off or their activity logged. All communications are done over HTTP and even HTTPS so problems with firewalls or hackers interested in the network are reduced.

In effect, this example of the system is adapted or configured (via software) to act as a protocol converter between HTTP, which is accessible from a Web Browser and the resultant protocol of the device that to be controlled. Even if the electronic device to be automated/controlled natively supports TCP and is well documented and supported (which is currently not a common case), then the subject system still provides value by acting as a bridge between a Web Browser and the device since a Browser typically does not have the ability and security permissions to access any TCP Device on the network. In fact, the Browser can typically only communicate with HTTP and as such (without operation of the control module in the present system) control of non-HTTP enabled devices is obstructed.

FIG. 16 illustrates an example, in accordance with certain aspects of the present invention, of a more specialized software option in terms of the operation for the genderless cable system variously described in connection with FIGS. 10 and 11 above. In this example, a software driver is employed to determine data speed and structure. The driver is specific to the device (i.e., control module) which is connected to the cable. For example, when connecting a serial cable to a Sony DVD player, the Sony DVD software driver is selected by the user. The driver transmits commands to the device at well-known serial data rates, measuring the received data returned by the device.

Communication, in this example, is established by a trial-and-error method where after (typically manually) a check is made at 500 if proper gender connection between, in the example of FIG. 1, a cable 290 end and device 300 to be controlled is or can be established. If incorrect, converter 274 is inserted to switch connector plug gender and a connection made between the cable and device at 502. Once physically connected, a check is made at 504 to determine if valid signal lines are present. If not, drivers are switched at 506. If so, communications are checked at 508 in which a) the smallest data bit period is measured to determine transmit speeds, b) data bit locations are determined by recording their respective time slot within the overall serial stream, c) and the parity setting is calculated for ODD, EVEN, or NONE. If no valid communications are detected the process is incremented to the next speed test at 510 and the process continues to narrow down possible solutions until only one remains. In any case, once a unique communication solution is found, the software driver (re)sets the control cable circuitry to a known state for proper operation with communication established at 512.

### Variations

Exemplary embodiments in accordance with various aspects of the present invention, together with details regarding a selection of features, have been set forth above. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

As for other details of the present invention, these may be appreciated in connection with the above-referenced patents and publications as well as is generally known or appreciated by those with skill in the art. The same may hold true with respect to method-based aspects of the invention in terms of additional acts as commonly or logically employed. Regarding such methods, including methods of manufacture and use, these may be carried out in any order of the events which is logically possible, as well as any recited order of events. Furthermore, where a range of values is provided, it is understood that every intervening value, between the upper and lower limit of that range and any other stated or intervening value in the stated range is encompassed within the invention. Also, it is contemplated that any optional feature of the inventive variations described may be set forth and claimed independently, or in combination with any one or more of the features described herein.

Though the invention has been described in reference to several examples, optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention.

The various illustrative processes described in connection with the embodiments herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, DisplayPort, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on, transmitted over or resulting analysis/calculation data output as one or more instructions, code or other information on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventor hereof intends that only those claims which use the words “means for” are to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

It is also noted that all features, elements, components, functions, acts and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “interfit”, “coupled” or “connected” (or any of these forms) may be used interchangeably herein and are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

Reference to a singular item includes the possibility that there are a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity.

Accordingly, while the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations (as referenced above, or otherwise) that define the inventive scope of the claims by features, functions, steps, or elements that are not within that scope.

Thus, the breadth of the inventive variations or invention embodiments is/are not to be limited to the examples provided and/or the subject specification, but rather only by the scope of the following claim language. That being said, I claim:

1. A network interface system for use with an electrical device, the system comprising:
a control module independent from the device and including memory, a processor to execute instructions and a first connector through which signals are passed; and
a communication cable, the communication cable having a second connector and an active interface,
wherein the processor is configured to:
receive electronic commands from a user interface device,
execute instructions based on the commands and information stored in the memory, and
provide for electronic communication with any of an IR cable and a serial cable through the connectors.

2. The system of claim 1, further comprising the electrical device, wherein the device is unautomated prior to incorporation in the system.

3. The system of claim 2, wherein the electrical device is selected from audio-visual components, lighting components, alarm components and household appliances.

4. The system of claim 1, wherein the processor is further configured to provide power to the cable for the electrical device.

5. The system of claim 1, wherein the processor is further configured to operate a relay cable.

6. The system of claim 1, wherein the IR cable includes an emitter at the active interface.

7. The system of claim 1, wherein the serial cable is RS232 standard.

8. The system of claim 1, wherein the processor is further configured to provide for electronic communication with a sensor function of the cable.

9. The system of claim 8, wherein a sensor at the active interface is selected from IR, temperature, voltage, contact-closure and power sensors.

10. The system of claim 1, wherein one of the connectors is a jack receptacle and the other connector is a multi-ring cylindrical plug.

11. The system of claim 10, wherein the first connector is the receptacle and the second connector is the plug.

12. The system of claim 1, wherein the control module further comprises a clock for a timer function to the electrical device.

13. The system of claim 1, wherein the adaptation for electronic communication is a driver downloaded to the memory in response executed processor instructions.

14. The system of claim 1, wherein the electronic communication is a control signal sent from the control module.

15. The system of claim 1, wherein the electronic communication is a sensor signal received by the control module.

16. A network interface communication cable system for use with an electrical device, the cable comprising:
an electrical connector at a first end;
an active interface at a second end; and
an integrated circuit board adjacent to the active interface and adapted to provide a plurality of configuration options for the active end.

17. The system of claim 16, wherein the active end configuration options are for a serial port interface.

18. The system of claim 17, wherein the serial port options are selected from gender, signal lines and communication speed.

19. The system of claim 16, further comprising a gender converter adapted to interfit with the serial port interface.

20. The system of claim 19, wherein the serial port interface comprises a plurality of pins and converter is a female-to-female type arrangement.

21. The system claim 16, wherein the active end configuration options are for a relays or contact closure devices.

22. The system claim 21, comprising at least one voltage output and at least one voltage sensing input.

23. The system of claim 21, wherein the cable further comprises a energy storage means.

24. The system of claim 16, wherein the cable further comprises an elongate body between the connector and the integrated circuit board.

25. The system of claim 16, further comprising a control module with an electrical connector adapted to interfit with the cable electrical connector, memory, and a processor to execute instructions,
wherein the processor is configured to:
receive electronic commands from a user interface device,
execute instructions based on the commands and information stored in the memory, and
provide for electronic communication with the active interface of the cable.

26. A computer readable medium having instructions stored thereon, which instructions, when executed cause one or more processors of a control module of a system including a cable with an active interface wherein the control module is independent of an electrical device to be controlled, to carrying out acts comprising:
receiving electronic commands from a user interface device,
issuing instructions based on the commands and information stored in the memory, and
providing electronic communication with the active interface of the cable to control the electrical device.
